(19) United States
(12) Patent Application Publication
(10) Pub. No.: US 2006/0239506 A1
(43) Pub. Date: Oct. 26, 2006

(54) Line textured target detection and tracking with applications to "Basket-run" detection

(75) Inventors: Zhong Zhang, Herndon, VA (US); Andrew J. Chosak, Arlington, VA (US); Niels Haering, Reston, VA (US); Alan J. Lipton, Herndon, VA (US); Gary W. Myers, Ashburn, VA (US); Peter L. Venetianer, McLean, VA (US); Weihong Yin, Herndon, VA (US)

Correspondence Address: VENABLE LLP, P.O. BOX 34385, WASHINGTON, DC, 20045-9998, US

(73) Assignee: ObjectVideo, Inc., Reston, VA (US)

(21) Appl. No.: 11/113,275

(22) Filed: Apr. 25, 2005

(51) Int. Cl. G06K 9/00; H04N 7/18; G06K 9/36

(52) U.S. Cl. 382/103; 382/291; 348/143

(57) ABSTRACT

A method of video surveillance may include pre-processing video data to obtain foreground edge information for at least one frame of said video data. The method may perform line segment detection on said foreground edge information to obtain one or more line segments. The line segment detection may be performed by means of an algorithm in which edge pixels are searched and line segments found are checked for validity. It may detect and track one or more targets based on said one or more line segments and may determine if at least one predetermined event is present in said at least one frame of said video data based on the detecting and tracking of said one or more targets.

### BACKGROUND OF THE INVENTION

1. Field of the Invention

This invention generally relates to surveillance systems. Specifically, the invention relates to a video-based surveillance system that can be used, for example, to detect shoplifting in retail stores.

2. Related Art

Some state-of-the-art intelligent video surveillance (IVS) system can perform content analysis on frames generated by surveillance cameras. Based on user-defined rules or policies, IVS systems may be able to automatically detect potential threats by detecting, tracking and analyzing the targets in the scene. One significant constraint of the system is that the targets have to be isolated in the camera views. Existing IVS systems have great difficulty in tracking individual targets in a crowd situation, mainly due to target occlusions. For the same reason, the types of targets that a conventional IVS system can distinguish are also limited.

In many situations, security needs demand much greater capabilities from an IVS. One example is the detection of shoplifting. Theft from stores, including employee and vendor theft, costs retailers many billions of dollars per year. Independent retail studies have estimated that theft from retail stores costs the American public between 20 and 30 billion dollars per year. Depending on the type of retail store, retail inventory shrinkage ranges from 0.5%-6% of gross sales, with the average falling around 1.75%. Whole retail store chains have gone out of business due to their inability to control retail theft losses. Although most stores have video surveillance cameras installed, most of them just serve as forensic tape providers. Intelligent real-time theft detection capability is highly desired but is not available.

One type of shoplifting stores, for example, grocery stores, encounter is called “basket-run,” which means that a person with a shopping cart goes straight to the exit without passing the register and paying for the merchandise in the basket.

### SUMMARY OF THE INVENTION

Embodiments of the invention include a method, a system, an apparatus, and an article of manufacture for automatic “basket-run” detection. Such embodiments may involve computer vision techniques to automatically detect “basket-runs” and other such events by detecting, tracking, and analyzing the shopping cart. This technology is not limited to shoplifting detection applications, but may also be used in other scenarios, for example, those in which the target of interest contains rich line textures.

Embodiments of the invention may include a machine-accessible medium containing software code that, when read by a computer, causes the computer to perform a method for automatic “basket-run” detection comprising the steps of: performing change detection on the input surveillance video; detecting shopping cart; tracking shopping; and detecting the “basket-run” event based on the movement of the shopping cart.

A system used in embodiments of the invention may include a computer system including a computer-readable medium having software to operate a computer in accordance with embodiments of the invention.

An apparatus according to embodiments of the invention may include a computer including a computer-readable medium having software to operate the computer in accordance with embodiments of the invention.

An article of manufacture according to embodiments of the invention may include a computer-readable medium having software to operate a computer in accordance with embodiments of the invention.

Exemplary features of various embodiments of the invention, as well as the structure and operation of various embodiments of the invention, are described in detail below with reference to the accompanying drawings.

### BRIEF DESCRIPTION OF THE DRAWINGS

The foregoing and other features of various embodiments of the invention will be apparent from the following, more particular description of such embodiments of the invention, as illustrated in the accompanying drawings, wherein like reference numbers generally indicate identical, functionally similar, and/or structurally similar elements. The left-most digits in the corresponding reference number indicate the drawing in which an element first appears.

FIG. 1 depicts a typical application scenario for some embodiments of the invention;

FIG. 2 depicts a conceptual block diagram of a system according to some embodiments of the invention;

FIG. 3 depicts a block diagram of a technical approach according to some embodiments of the invention;

FIG. 4 depicts a block diagram of a video pre-processing module according to some embodiments of the invention;

FIG. 5 depicts a block diagram of a line segment detection module according to some embodiments of the invention;

FIG. 6 depicts an algorithm to detect a single line segment according to some embodiments of the invention;

FIG. 7 illustrates how to predict line direction when detecting the line segment according to some embodiments of the invention;

FIG. 8 depicts a block diagram of a shopping cart detection module according to some embodiments of the invention;

FIG. 9 depicts a block diagram of a line segment clustering module according to some embodiments of the invention;

FIG. 10 depicts an algorithm to extract a single line segment cluster according to some embodiments of the invention;

FIG. 11 depicts a block diagram of a shopping cart tracking module according to some embodiments of the invention;

FIG. 12 depicts a procedure to perform “basket-run” detection according to some embodiments of the invention; and

FIG. 13 illustrates an example of a detected “basket-run” alert according to some exemplary embodiments of the invention.

### DEFINITIONS

The following definitions are applicable throughout this disclosure, including in the above.

A “video” refers to motion pictures represented in analog and/or digital form. Examples of video include: television, movies, image sequences from a video camera or other observer, and computer-generated image sequences.

A “frame” refers to a particular image or other discrete unit within a video.

A “line segment” refers a list of edge pixels fit into a line. It has a start point, an end point, and a direction from the start point side to the end point side.

An “object” refers to an item of interest in a video. Examples of an object include: a person, a vehicle, an animal, and a physical subject.

A “target” refers to the computer's model of an object. The target is derived from the image processing, and there is a one-to-one correspondence between targets and objects. The target in some exemplary embodiments of the invention may be a shopping cart.

A “computer” refers to any apparatus that is capable of accepting a structured input, processing the structured input according to prescribed rules, and producing results of the processing as output. The computer can include, for example, any apparatus that accepts data, processes the data in accordance with one or more stored software programs, generates results, and typically includes input, output, storage, arithmetic, logic, and control units. Examples of a computer include: a computer; a general purpose computer; a supercomputer; a mainframe; a super mini-computer; a mini-computer; a workstation; a micro-computer; a server; an interactive television; a web appliance; a telecommunications device with internet access; a hybrid combination of a computer and an interactive television; a portable computer; a personal digital assistant (PDA); a portable telephone; and application-specific hardware to emulate a computer and/or software. A computer can be stationary or portable. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; software programs; computer programs; and programmed logic.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone, wireless, or other communication links. Examples of a network include: an internet, such as the Internet; an intranet; a local area network (LAN); a wide area network (WAN); and a combination of networks, such as an internet and an intranet.

An “information storage device” refers to an article of manufacture used to store information. An information storage device has different forms, for example, paper form and electronic form. In paper form, the information storage device includes paper printed with the information. In electronic form, the information storage device includes a computer-readable medium storing the information as software, for example, as data.

### DETAILED DESCRIPTION OF EMBODIMENTS OF THE PRESENT INVENTION

Exemplary embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

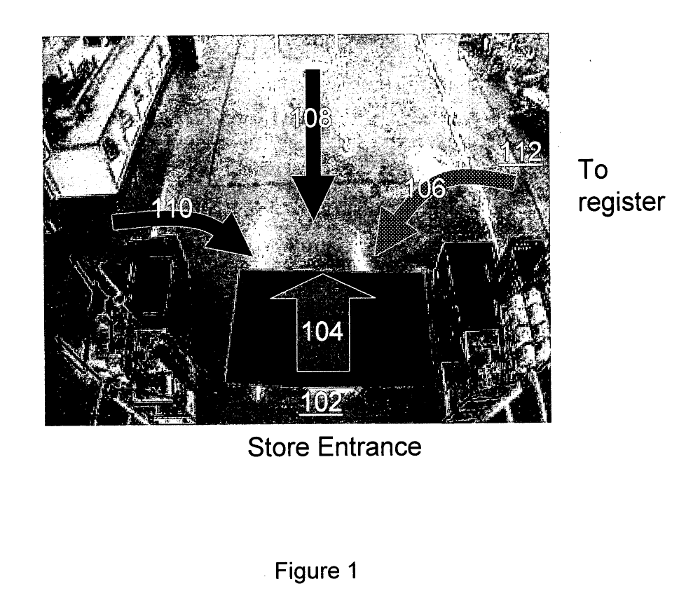

FIG. 1 depicts an exemplary application scenario for embodiments of the present invention. The picture shows one entrance area of a retail store. Customers are expected to only enter the store from entrance 102 into the inside of the store. The right side of the image 112 leads to the register area, and someone who exits from that direction may be considered as normal. Thus, of the four traffic flow patterns 104, 106, 108 and 110, 104 and 106 may be considered to be normal, but 108 and 110 may be considered to be suspicious when not only a human is observed but also a shopping cart is observed in the flow. So the goal is to automatically detect a human with a shopping cart exiting the store using entrance 102 and following a path 108 or 110. A conventional closed-circuit television (CCTV) camera will not perform any advanced analysis on the scene, and even state-of-the-art existing IVS systems are not be able to fulfill this task because of a number of constraints, including a busy background and crowded foreground. These constraints make it difficult to separate out individual targets and then further analyze their properties and track their moving trajectories. Embodiments of the present invention may provide a solution to this problem, which may include shopping cart detection and tracking algorithms. Because any potential “basket-run” event must involve a shopping cart, we identify that the shopping cart may be a particular object of interest.

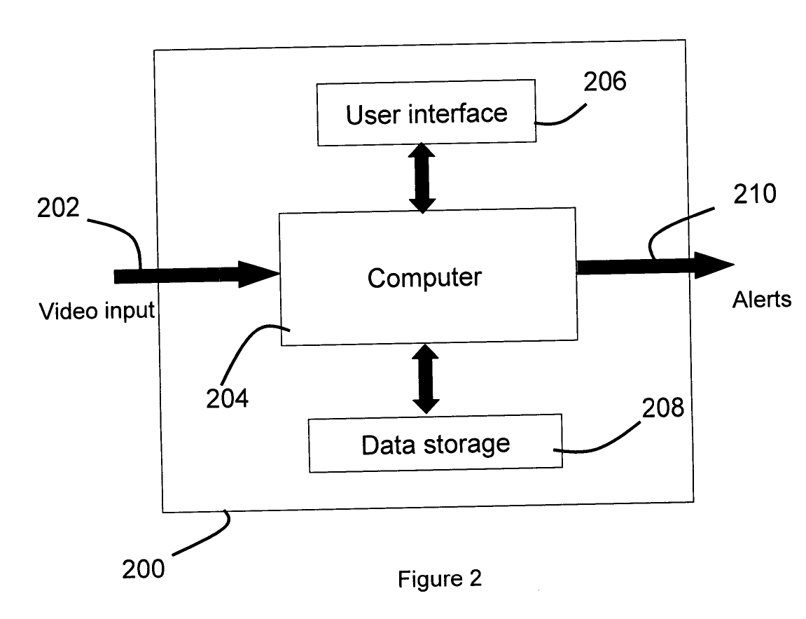

FIG. 2 depicts a conceptual block diagram of an embodiment of an inventive “basket-run” detection IVS system 200. The input 202 may be, for example, a normal CCTV video signal; it may, alternatively, be another type of video source. Block 204 is a central processing unit that may be used to perform scene content analysis. The user may set up the system through the user interface 206. Once any event is detected, alerts 210 may be sent to appropriate destinations (for example, but not limited to, staff, police, etc.); such alerts may be furnished with necessary information and/or instructions for further attention and investigations. The video data, scene context data, and other event related data may be stored in data storage 208 for later forensic analysis.

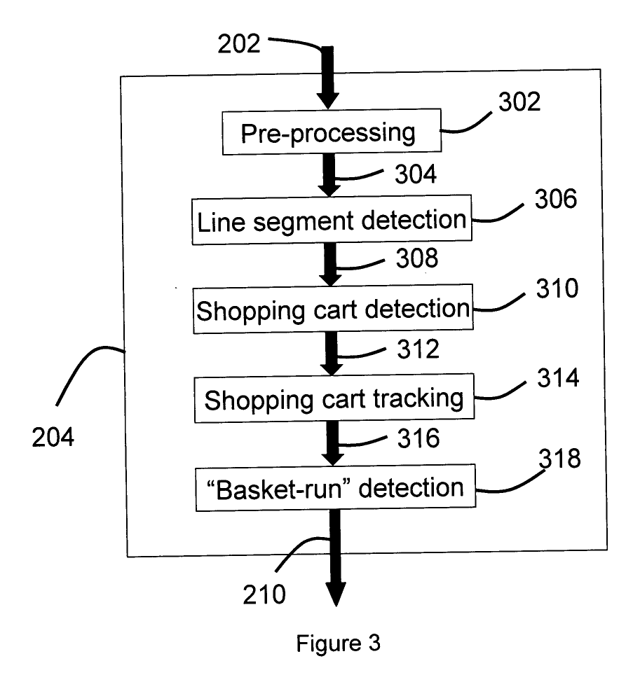

FIG. 3 depicts a conceptual block diagram of “basket-run” detection algorithms according to embodiments of the invention. To detect a shopping cart, it may be noted that most of shopping carts have similar size and contain rich line texture patterns that can be used to distinguish them from other types of targets in the store. From a computer vision point-of-view, these line texture patterns may be reflected by a cluster of parallel line segments, and this may be used as a clue to detect a shopping basket.

The input video frame may first be pre-processed by module 302. The output 304 may include one or more foreground masks and a foreground edge map. Module 306 may then perform line segment detection on the edge map. The output 308 may be a list of line segments. Module 310 may then be used to detect and extract potential shopping carts from the list of line segments, and the output 312 may be a list of shopping cart instances for each frame. Module 314 may then perform tracking of each shopping cart target. The tracking process enables one to obtain the target moving trajectory and to avoid duplicated alerts. Finally, module 318 may be used to perform “basket-run” event detection based on the tracked target data as well as on user-defined rules, which may include, but which are not limited to, such rules as exit area, sensitive moving direction, etc.

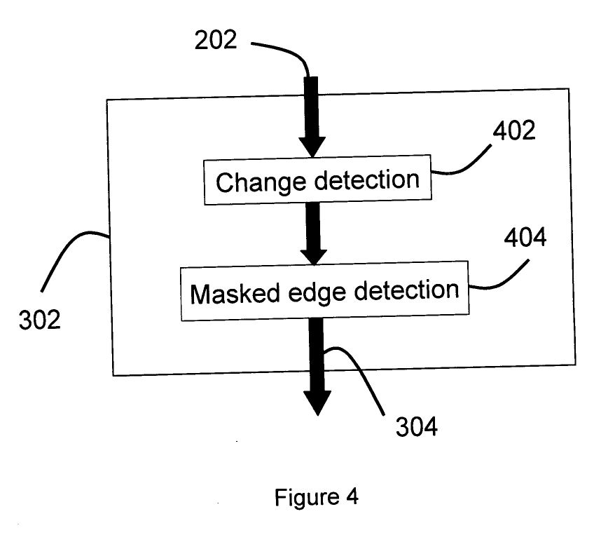

FIG. 4 lists the two major components of the pre-processing module 302, according to some embodiments of the invention. Change detection 402 may be used to separate the foreground moving area from the background scene. All of the following processes may be generally focused on the foreground areas, which may result in reduced computational cost. In addition, potential false alarms from parked shopping carts and other textured static objects may also be removed by this process. Change detection has been studied extensively in recent years, and many algorithms are available publicly. In embodiments of the present invention, the final performance does not rely on any particular change detection algorithm. The output of the change detection 402 may be foreground mask for each frame.

The second component in pre-processing module 302, according to the embodiment shown in FIG. 4, is edge detection 404. While other edge detection algorithms may be used, an exemplary embodiment of the invention uses the Canny edge detection here because it produces single-pixel-width edges. Edge detection 404 is only performed on the foreground area, which may require some modifications to the Canny edge detector to incorporate the foreground mask information.

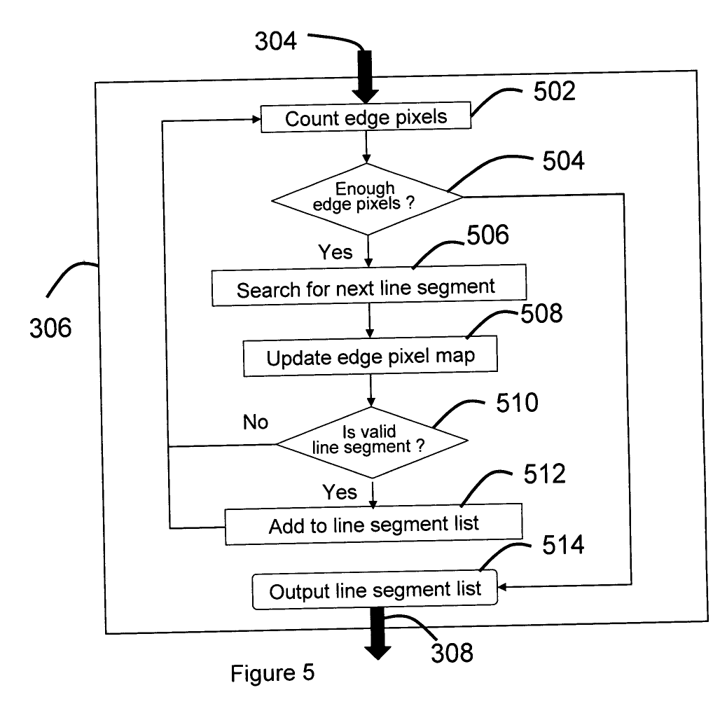

FIG. 5 depicts the block diagram of a line segment detection module 306 according to some embodiments of the invention. The input 304 to the module 306 is an edge pixel map of the frame. Embodiments of the invention may use a deterministic method to extract all the line segments out from an edge pixel map. The algorithm iteratively searches the edge pixel map to find a new line segment until there are not enough unused edge pixels left. Each edge pixel can only be in one line segment, and after being used, it will be removed from the edge pixel map. In particular, the process may begin by determining a number of edge pixels remaining and determining if this number is sufficient 504 to continue to find at least one more line segment. The threshold to check this condition may be determined by user input parameters on the rough image size of a shopping cart. For example, if the rough image width of a shopping cart is sixty pixels, the threshold on the sufficient remaining edge pixels may be, for example, one third of it, that is, twenty pixels. This threshold is called the minimum line segment length threshold.

If there are not sufficient unused edge pixels left, the process may proceed to block 514 and may output a list of line segments 308. If there are sufficient unused edge pixels left, the process may continue to block 506 to search for a new line segment. The edge pixel map may then be updated 508 to eliminate the used pixels, as noted above. Each new line segment provided by block 506 may be further validated 510 based on its length and linearity. If a line segment has length much shorter than the image dimension of an expected shopping cart or if its overall linearity is too low, this line may be considered as an invalid line segment. A valid line segment may be added to a list 512. An invalid line segment may be discarded, and the process may return to block 502. As discussed above, the output of the module 308 may be a list of all the extracted valid line segments.

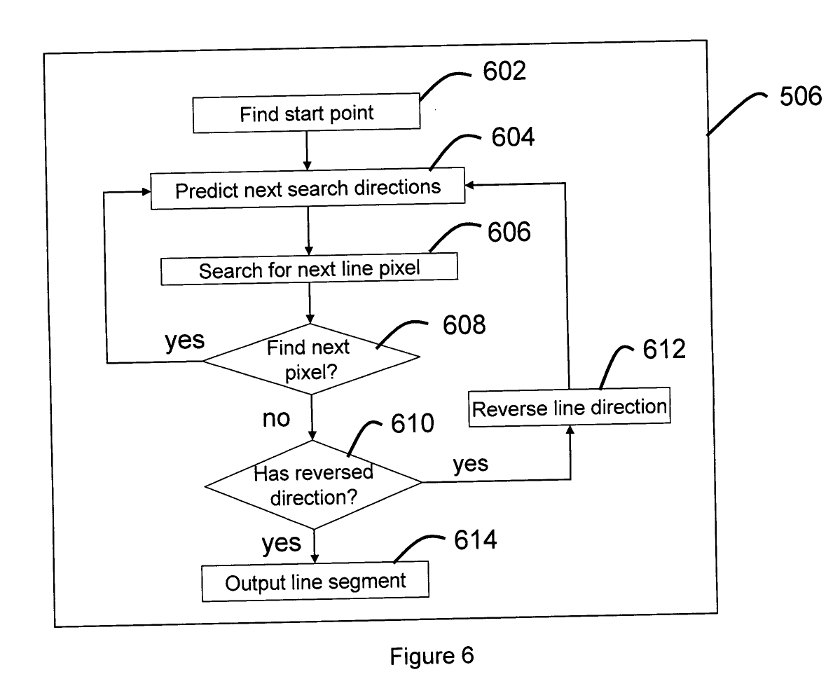

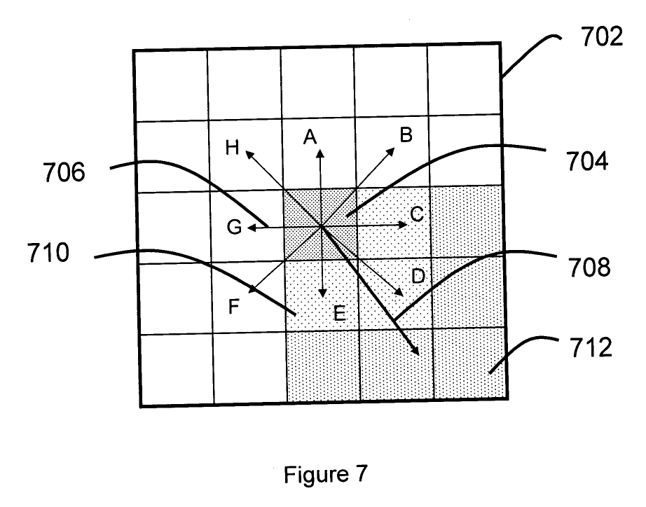

FIG. 6 illustrates an exemplary procedure to extract a new line segment from a given edge pixel map, according to some embodiments of the invention. First, the process may search the edge pixel map to find the first available edge pixel as a start point of the line segment 602. For the first line segment, this start point may be obtained by scanning through the whole edge pixel map from the top left corner until the first unused edge point is located. For all subsequent line segments, the search may be speeded up by using the start point of the preceding line segment as the scanning start position. The process may next proceed with block 604 to predict next search directions for the end point based on an estimated line direction; this will be discussed further below, in connection with FIG. 7. The process may then loop through each predicted search position to see if it is an edge pixel 606. If it finds an edge pixel 608, the pixel may be added to the line segment as the new end point, and the process may loop back to block 604. The process may need to search the next line pixel in both directions. When it can not find next line pixel in one direction, the process may proceed to block 610 to determine if it has searched the reverse direction already. If this is the case, this may indicate the end of the search process on the current line segment, and the process may output the line segment 614. If this is not the case, the process may reverse the line direction 612, so that the end point becomes the start point and the start point becomes the current end point and may then loop back to block 604.

FIG. 7 may be used to illustrate how the process may predict the next search positions, as in various embodiments of block 604 of FIG. 6, based on an existing line segment. Area 702 shows a region of an image, where each block indicates one pixel location. Area 704 indicates the current end point (pixel) of the current line segment. Three different scenarios may be considered when predicting the next search positions. The first scenario is a special case in which the current end point is also the start point. In this case, we search all of its eight neighboring directions A-H as shown by reference numeral 706.

Once there are multiple pixels in a line segment, one may estimate its direction using information provided by the pixels of the line segment. One way to determine the line direction is to perform clustering of the line segment pixels into two groups, the starting pixels and the ending pixels, which correspond to the first half and second half of the line segment, respectively. The line direction may then be determined by using the average locations of the two groups of pixels.

When there is a current line direction available, for example, as may be indicated by arrow 708, one may pick the top three directions, C, D, and E, indicated by reference numeral 710, that have minimum angle distances from the line direction. Two scenarios may be considered in this case. One is that the line may not yet be long enough to become a consistent line segment, where we are not sure if the list of pixels we have is a part of a line segment or just a cluster of neighboring edge pixels. One way to determine if the current line segment is sufficiently consistent is to use the minimum length threshold discussed above; if the line segment is less than this threshold, it may be considered not to be sufficiently consistent. To avoid extracting a false line, one may include only the three direct neighboring locations 710 as the next search locations. The other scenario is that the line segment is long enough and may be consistently extracted. In this case, one may not want to miss any portion of the line due to an occasional small gap in the edge map caused by noise. Thus, further neighborhood search locations may be included as indicated by reference numeral 712.

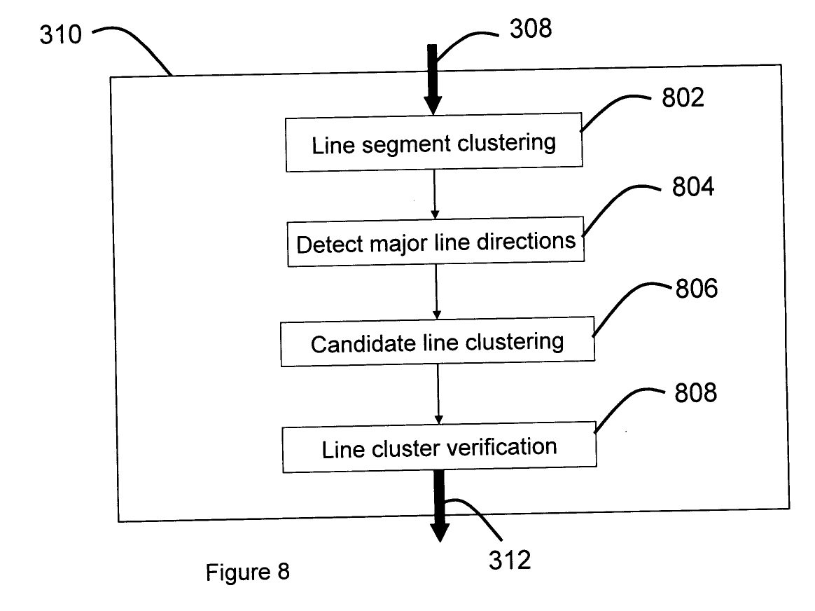

FIG. 8 shows an exemplary procedure according to embodiments of the invention to detect shopping baskets in a video frame (reference numeral 310 in FIG. 3). The input to this module 308 may be a list of line segments in the image. These line segments may then be clustered 802 into groups based on their locations and on the image size of a shopping cart. Each group of clustered line segments may correspond to a potential shopping cart. Note that almost any object may produce line segments; the discriminatory feature of a shopping cart is that it is much more likely to produce high density parallel line segments. Module 804 may be used to detect principal line segment directions, for example, by forming a line direction histogram or by another appropriate technique. For the case using a line direction histogram, only directions with peak values in the histogram may be considered to be major directions. Those line segments without principal line directions may then be filtered out. The rest of the line segments may then clustered be again 806 to provide a bounding box of the potential shopping cart. In this re-clustering, for each bounding box of clustered line segments, one may define a line density measure as the total number of line pixels divided by the perimeter of the bounding box. The clustering procedure may iteratively adjust the number of line segment candidates in the cluster such that the line density reaches a maximum when the bounding box size is within a range of the shopping cart image size. The final clustering of line segments may be verified 808 such that a particular cluster is considered to be a shopping cart if its bounding box size is close to a bounding box that would correspond to a real shopping cart and the its line density is high enough. Large numbers of experiments have shown that a shopping cart generally has much higher line density than other type of targets, such as human targets. A number around three may, for example, be used as a threshold density. In an exemplary system according to embodiments of the invention, this number may also be a user adjustable parameter to control the sensitivity of the shopping cart detection. The higher the value of this threshold, the higher the miss rate but the lower the false alarm rate. The output of this module 312 may be a list of detected shopping carts represented by one or more clusters of parallel line segments and their bounding boxes.

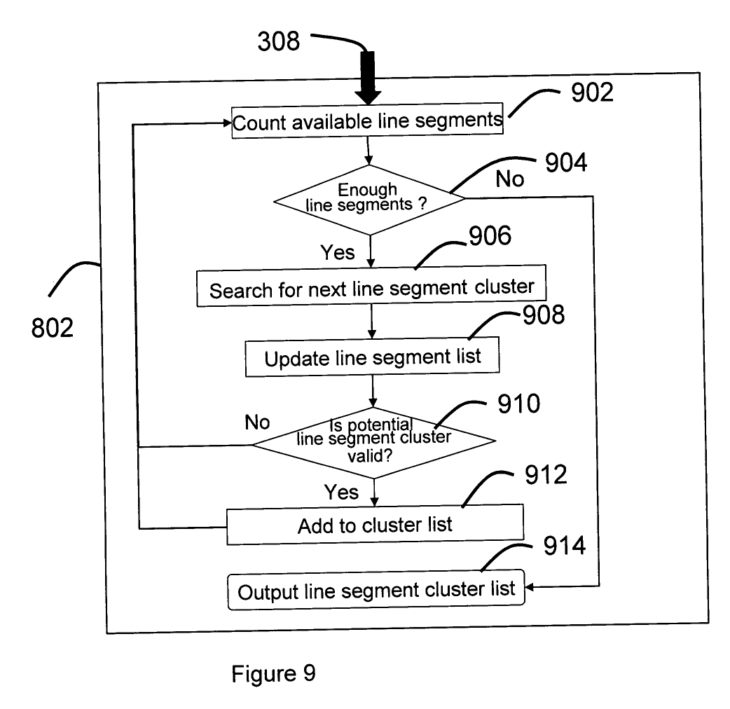

FIG. 9 depicts a block diagram of a line segment clustering module 802 according to some embodiments of the invention. The input 308 to the module 802 may include a list of valid line segments. Embodiments of the invention may use an iterative process to cluster all of the line segments into a number of spatially distributed groups. The algorithm may iteratively cluster neighboring line segments into a group. Each line segment may only be in one cluster, and after being used, it may be removed from the line segment list.

In particular, the process may begin by determining a number of line segments remaining 902 and determining if this number is sufficient 904 to continue to find at least one more line segment cluster. If not, the process may proceed to block 914 and may output a list of line segments. If so, the process may continue to block 906 to search for a new line segment cluster. The threshold to check this condition may be determined by user adjustable parameters on the minimum line segment number for a potential shopping cart target. After extracting a new line segment cluster, the line segment list may be updated 908 to eliminate the used line segments, as noted above. Each new line segment cluster provided by block 906 may be further validated 910 based on its size and line density. If a line segment cluster is much smaller than the image size of an expected shopping cart, or if its line density is lower than a user set parameter, it may be considered as an invalid line segment cluster that is unlikely to be a potential shopping cart. A valid line segment cluster may be added to a list 912. An invalid line segment cluster may be discarded, and the process may return to block 902. As discussed above, the output of the module 314 may be a list of all the extracted valid line segment clusters.

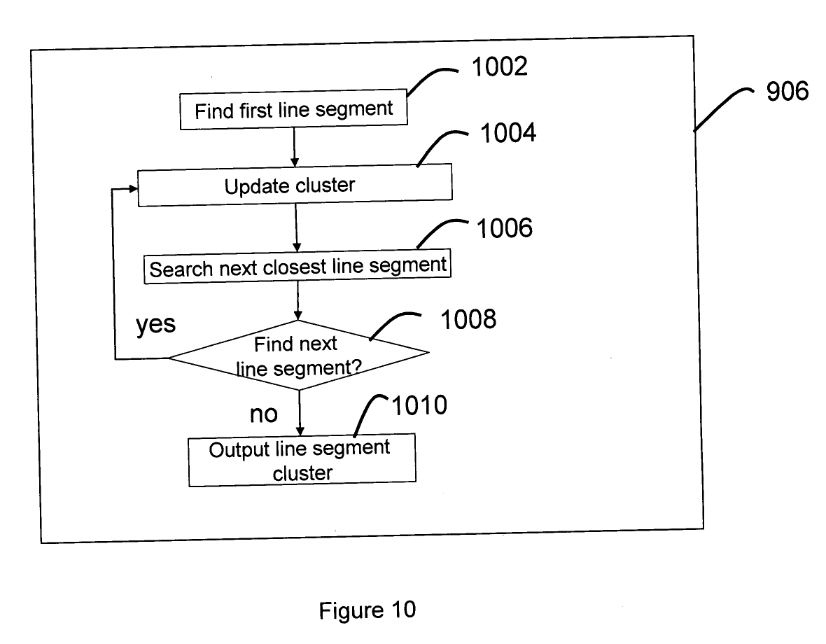

FIG. 10 illustrates an exemplary procedure to generate a new line segment cluster from a given line segment list, according to some embodiments of the invention. First, the process may search the line segment list to find the first line segment 1002. Here we define the distance from a line segment L to a point P as the minimum distance of the three key points of the line segment to that point: Dₗₚ=MIN(Dₛₚ, Dₑₚ, D_{cp}) when Dₛₚ, Dₑₚ and D_{cp} are the distance from the start point, end point and center point to the point P, respectively. The first line segment is the line segment that has the minimum distance to the centroid of all of the available line segments. The process may next proceed with block 1004 to update the current line segment cluster properties, which include size, centroid location, etc. The process may then loop through all the remaining line segments to find the one with minimum distance to the updated cluster centroid 1006. Further testing may be performed 1008 to see if this closest line segment should be included in the current line segment cluster. The closest line segment may need to pass several tests to be considered as valid, which tests may include, for example: whether it is close enough to the current centroid, where a distance threshold may be the mean image size of the shopping cart; and whether the new line segment does not decrease the line density of the cluster if the cluster is already bigger than the minimum shopping cart size provided by the user. If the closest line segment is considered as valid, it may be included in the current line cluster, and the process may loop back to block 1004. Otherwise, the process may proceed to block 1010 to output the current line segment cluster.

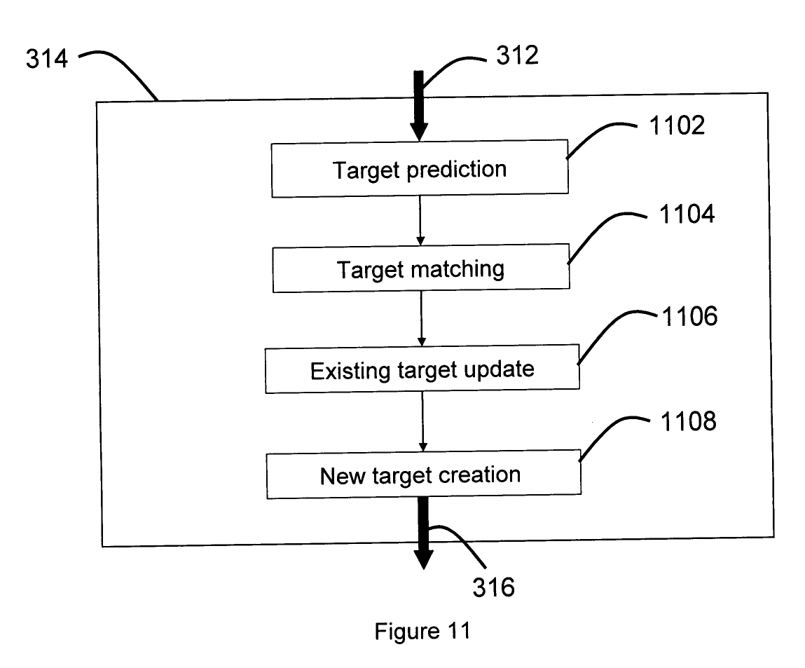

FIG. 11 depicts an exemplary procedure to perform shopping cart target tracking according to embodiments of the invention. Once a new shopping cart is detected, it may be tracked while it is still in the camera field of view. At each new timestamp, the system may have a list of existing shopping cart targets and a list of input newly-detected shopping cart target instances. A target matching module 1104 may be used to match all the existing targets to the newly-observed targets based on their predicted locations, which may be provided by target prediction 1102. If an existing target can be matched with a corresponding new target, it may be updated using this newly observed target 1106. If an existing target has not been able to be matched with a new observation for a certain time duration, this target may be removed from the target list as having disappeared from the scene. If a newly-detected target does not have a matching existing target, a new target may be created 1108 from this observed instance. The output of this module 316 may include a list of tracked shopping cart targets.

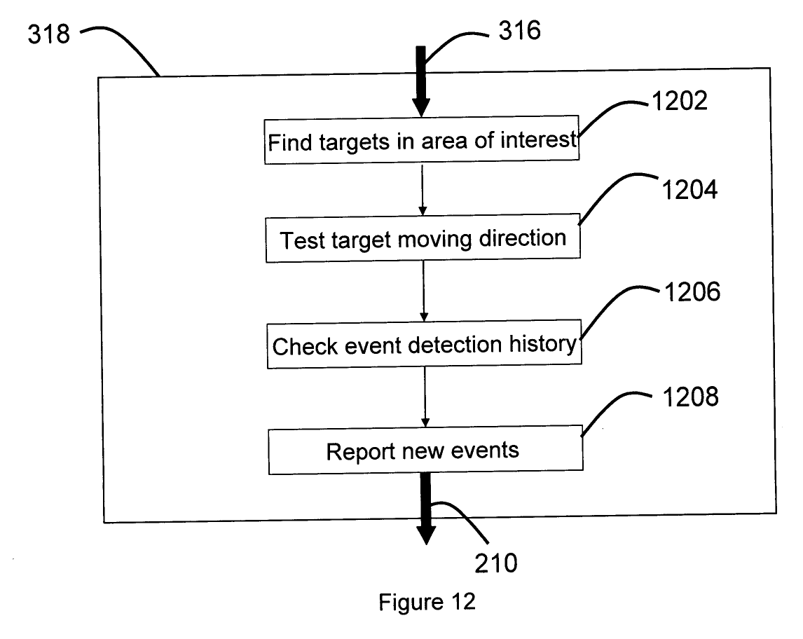

FIG. 12 depicts a block diagram of “basket-run” event detection module 318 according to some embodiments of the invention. The region of interest and the direction of interest may be provided by the user. In the example application scenario as illustrated in FIG. 1, the region of interest may, for example, be around store entrance 102; and the direction of interest may, for example, be between the direction arrows 108 and 110. If a tracked target in the input target list moves into the area of interest 1202 with a direction within the range of the direction of interest 1204, this event may be considered as a violation, and an event detection history may be checked 1206. If this is a new violation of the target, the system may report it as a new “basket-run” event 1208; otherwise, it may be treated as a new evidence of a reported event. The output of the module may include a list of detected events.

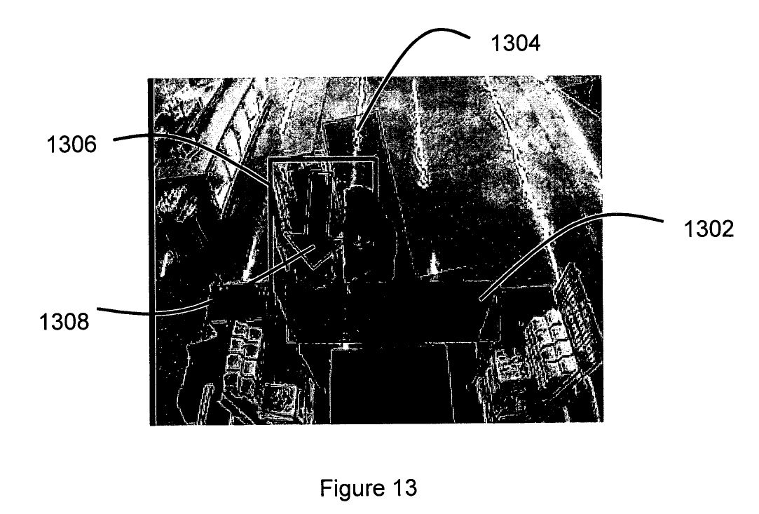

FIG. 13 shows a sample alert snapshot that may also be included in the output 210 in some embodiments of the invention. In FIG. 13, reference numeral 1302 identifies a user-defined exit region; 1304 refers to the direction of interest; 1306 shows the bounding box of a detected shopping cart; and 1308 identifies the instant moving direction of the shopping cart detected.

The embodiments and examples discussed herein should be understood to be non-limiting examples.

The invention is described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. A method of video surveillance comprising:
pre-processing video data to obtain foreground edge information for at least one frame of said video data;
performing line segment detection on said foreground edge information to obtain one or more line segments;
detecting and tracking one or more targets based on said one or more line segments; and
determining if at least one predetermined event is present in said at least one frame of said video data based on the detecting and tracking of said one or more targets.

2. The method according to claim 1, wherein said pre-processing comprises:
detecting foreground pixels of said video data; and
detecting at least one edge pixel based on said foreground pixels.

3. The method according to claim 1, wherein said performing line segment detection comprises:
searching edge pixels of said foreground edge information to find at least one line segment; and
determining if each said line segment is a valid line segment.

4. The method according to claim 3, further comprising:
counting said edge pixels of said foreground edge information, prior to said searching, to determine if there are sufficient edge pixels to find a line segment.

5. The method according to claim 4, further comprising:
discarding those of said edge pixels forming a line segment that has been found in said searching.

6. The method according to claim 3, wherein said searching comprises:
choosing an edge pixel to be a start point of a line segment;
predicting at least one search direction for a next pixel of a line segment; and
searching for a next pixel of a line segment using said at least one search direction.

7. The method according to claim 6, further comprising:
determining if a line segment has reversed direction if a next pixel is not found in said searching for a next pixel.

8. The method according to claim 6, wherein said predicting at least one search direction comprises:
searching directions of all pixels directly surrounding said start point for an edge pixel if said start point is the only point of said line segment;
searching three neighboring pixel directions directly surrounding a previously-selected pixel of said line segment if it has not yet been determined that said line segment has been consistently detected; and
searching all neighboring pixel directions directly surrounding a previously-selected pixel of said line segment if it has been determined that said line segment has been consistently detected.

9. The method according to claim 1, wherein said detecting and tracking comprises:
detecting and tracking at least one shopping cart;
and wherein said predetermined event comprises a “basket-run” event.

10. The method according to claim 1, wherein said detecting and tracking comprises:
performing a first clustering on said one or more line segments to obtain one or more first line clusters;
filtering each of said first line clusters to remove lines not in a principal direction to obtain one or more filtered line clusters; and
performing a second clustering on the line segments of each of said filtered line clusters to obtain one or more target bounding boxes.

11. The method according to claim 10, wherein said performing a first clustering comprises:
finding a first line segment based on a centroid of all of said one or more line segments and adding said first line segment to a cluster; and
searching for at least one additional line segment to said cluster based on a centroid of said cluster.

12. The method according to claim 11, wherein said searching for at least one additional line segment comprises:
adding each additional line segment to said cluster and determining an updated centroid of said cluster.

13. The method according to claim 11, wherein said performing a first clustering further comprises:
validating said cluster based on at least one characteristic selected from the group consisting of: size and line segment density.

14. The method according to claim 10, wherein said filtering each of said first line clusters comprises:
forming a histogram of line directions for the line segments of each of said first line clusters; and
selecting a principal direction based on said histogram for each of said first line clusters.

15. The method according to claim 10, wherein said second clustering comprises:
iteratively adjusting a number of line segments in each filtered line cluster to maximize a line density subject to a constraint on a target bounding box size for each filtered line cluster.

16. The method according to claim 10, further comprising:
verifying whether each of said one or more target bounding boxes corresponds to a target.

17. The method according to claim 16, wherein said verifying comprises:
examining each target bounding box with respect to at least one of the features selected from the group consisting of: bounding box size and bounding box line density.

18. The method according to claim 1, wherein said detecting and tracking comprises:
predicting a location of at least one target in a current video frame;
matching each target from a previous video frame with a target in said current video frame, including:
removing from consideration any target that was present in said previous video frame and is not matched with a target in said current video frame; and
determining that any target not found in said previous video frame and found in said current video frame is a new target.

19. The method according to claim 1, wherein said determining if at least one predetermined event is present comprises:
finding at least one target in a region of interest; and
determining that at least one target in said region of interest is moving in a direction of interest.

20. The method according to claim 19, wherein said determining if at least one predetermined event is present further comprises:
checking an event detection history; and
reporting that any event detected but not present in said event detection history is a new event.

21. The method according to claim 1, further comprising:
outputting at least one alert based upon said determining if at least one predetermined event is present.

22. A computer-readable medium containing instructions that, when executed on a computer system, cause the computer system to implement the method according to claim 1.

23. The computer-readable medium according to claim 22, wherein said detecting and tracking comprises:
detecting and tracking at least one shopping cart;
and wherein said predetermined event comprises a “basket-run” event.

24. A video-based surveillance system comprising:
a computer system; and
the computer-readable medium according to claim 22, said computer-readable medium coupled to said computer system to enable said computer system to read and execute said instructions.

25. The video surveillance system according to claim 24, further comprising:
at least one video source coupled to said computer system to provide said video data.

26. A method of video surveillance comprising:
pre-processing video data to obtain foreground edge information for at least one frame of said video data;
performing line segment detection on said foreground edge information to obtain one or more line segments, said performing line segment detection comprising:
searching edge pixels of said foreground edge information to find at least one line segment; and
determining if each said line segment is a valid line segment;
detecting and tracking one or more targets based on said one or more line segments; and
determining if at least one predetermined event is present in said at least one frame of said video data based on the detecting and tracking of said one or more targets.

27. The method according to claim 26, further comprising:
counting said edge pixels of said foreground edge information, prior to said searching, to determine if there are sufficient edge pixels to find a line segment.

28. The method according to claim 26, wherein said searching comprises:
choosing an edge pixel to be a start point of a line segment;
predicting at least one search direction for a next pixel of a line segment; and
searching for a next pixel of a line segment using said at least one search direction.

29. A method of performing line segment detection in video, comprising:
searching edge pixels derived from said video to find at least one line segment; and
determining if each said line segment is a valid line segment.

30. The method according to claim 29, further comprising:
counting said edge pixels, prior to said searching, to determine if there are sufficient edge pixels to find a line segment.

31. The method according to claim 30, further comprising:
discarding those of said edge pixels forming a line segment that has been found in said searching.

32. The method according to claim 29, wherein said searching comprises:
choosing an edge pixel to be a start point of a line segment;
predicting at least one search direction for a next pixel of a line segment; and
searching for a next pixel of a line segment using said at least one search direction.

33. The method according to claim 32, further comprising:
determining if a line segment has reversed direction if a next pixel is not found in said searching for a next pixel.

34. The method according to claim 32, wherein said predicting at least one search direction comprises:
searching directions of all pixels directly surrounding said start point for an edge pixel if said start point is the only point of said line segment;
searching three neighboring pixel directions directly surrounding a previously-selected pixel of said line segment if it has not yet been determined that said line segment has been consistently detected; and
searching all neighboring pixel directions directly surrounding a previously-selected pixel of said line segment if it has been determined that said line segment has been consistently detected.

35. A computer-readable medium containing instructions that, when executed on a computer system, cause the computer system to implement the method according to claim 29.

36. A system comprising:
a computer system; and
the computer-readable medium according to claim 35, said computer-readable medium coupled to said computer system to enable said computer system to read and execute said instructions.

37. The system according to claim 36, further comprising:
at least one video source coupled to said computer system to provide said video.
